(19) United States
(12) Patent Application Publication
(10) Pub. No.: US 2018/0141509 A1
(43) Pub. Date: May 24, 2018

(54) Renewable Energy Powered Blind Spot Sensor and Stand Alone Power Module

(71) Applicant: Terrace Thompson, Queen Creek, AZ (US)

(72) Inventors: Terrace Barrell Thompson, Queen Creek, AZ (US); Marshall James Thompson, Queen Creek, AZ (US)

(73) Assignee: Terrace Thompson, Queen Creek, AZ (US)

(21) Appl. No.: 15/807,616

(22) Filed: Nov. 9, 2017

Related U.S. Application Data
(60) Provisional application No. 62/425,608, filed on Nov. 22, 2016.

(51) Int. Cl. B60R 16/03; F03D 9/32; B60R 11/04; B60R 16/033

(52) U.S. Cl. CPC B60R 16/0307; F03D 9/32; B60R 1/006; B60R 16/033; B60R 11/04

(57) ABSTRACT

A renewable energy power module can power a blind spot monitoring system for alerting a driver when a vehicle is positioned in a blind spot. The power module can power side-view mirror mounted ultrasonic and thermal infrared blind spot sensors. The renewable energy power system can also power side-view mirror mounted miniature first person view (FPV) cameras that wireless transmit the blind spot video data to a dash-mounted FPV receiver and video monitor. Lastly, the renewable energy power module can be used to power and charge the rechargeable batteries of other low voltage devices that may be used on motorized and human powered vehicles.

### REFERENCES CITED

U. S. PATENT DOCUMENTS

| | | | |
|---|---|---|---|
| 4,349,823 | July 1980 | Katsutoshi Tagami, et al. | 343/7 VM |
| 5,325,096 | June 1994 | Pakett, et al. | 342/70 |
| 5,339,075 | August 1994 | Terrill Abst, et al. | 340/903 |
| 5,517,196 | May 1996 | Pakett, et al. | 342/70 |
| 5,786,772 | July 1998 | Schofield, et al | 340/903 |
| 6,727,808 B1 | April 2004 | Uselmann, et, al. | 340/436 |

U. S. PROVISIONAL PATENT APPLICATION DOCUMENTS

| | | |
|---|---|---|
| 62/425,608 | November 2016 | Thompson, et al., |

### BACKGROUND OF THE INVENTION

### Field of the Invention

The present invention relates to blind spot sensors and more particularly pertains to a blind spot sensor that can be powered by a rechargeable lithium-ion battery that contains a renewable energy power module that can recharge the battery and directly power the blind spot sensor when the battery has been fully charged.

### Description of the Prior Art

The use of smart blind spot sensors is known in the prior art. U.S. Pat. No. 5,517,196 describes a system for alerting a driver when a vehicle is positioned in a blind spot of the driver's vehicle. Another type of smart blind spot sensor is U.S. Pat. No. 5,339,075 having an ultrasonic transmitter for emitting acoustic energy to identify a vehicle positioned in a blind spot. Another type of smart blind spot sensor is U.S. Pat. No. 5,786,772 having a blind spot detector positioned within an external mirror of a vehicle for detecting vehicles positioned in the blind spot. Another type of smart blind spot sensor is U.S. Pat. No. 5,325,096 having a radar system for detecting vehicles positioned in the blind spot of the driver's vehicle. Another type of smart blind spot sensor is U.S. Pat. No. Des. 356,317 showing a rear view mirror. Another type of smart blind spot sensor is U.S. Pat. No. 4,349,823 having a radar system for detecting vehicles positioned in the blind spots of a driver's vehicle.

The contents of the above mentioned publications are incorporated herein by reference in their entirety

### SUMMARY OF THE INVENTION

The present invention generally comprises a renewable energy power module that power devices which alerts the driver of a vehicle when there is a threat of changing lanes into the path of another vehicle. These devices are commonly referred to as blind spot sensors. There are many types of blind spot sensors that include ultrasonic, infrared (IR) and first person view (FPV) cameras. The sources of the renewable energy power are a micro-wind turbine and micro-solar arrays capable of generating enough direct-current power to power the blind spot sensors or any other devices in moving vehicles that contain rechargeable batteries.

When a vehicle is driven, the speed of the vehicle generates enough wind energy to rotate a micro-turbine producing alternating-current power. This power can be rectified to provide voltages of direct-current power. This direct-current voltage can be further regulated to an appropriate direct current voltage needed to directly power blind spot sensors and charge lithium-ion rechargeable batteries.

When a vehicle is driven in sunlight, the micro-solar arrays generate enough direct-current voltage to directly power blind spot sensors and charge lithium-ion rechargeable batteries.

The lithium-ion rechargeable batteries provide the temporary source of power to the blind spot sensor or other rechargeable devices when the vehicle is not moving or when traveling at night. To save battery life, the device will automatically shut off after a set period of time where no vehicle movement is detected and will automatically turn on after vehicle motion is detected.

While the foregoing provides a general overview of the some of the various features and functionalities of the subject invention, a better understanding of the objects, advantages, features, properties and relationships of the subject invention will be obtained from the following detail description and accompanying drawings which set forth illustrative embodiments and which are indicative of the various ways in which the principles of the subject invention may be employed.

### BRIEF DESCRIPTION OF THE DRAWINGS

For a better understanding of the subject invention, reference may be had to preferred embodiment shown in the attached drawings which:

FIG. 1 is a pictorial diagram and layout of an exemplary ultrasonic blind spot sensor with a renewable energy power module that consist of a micro wind-powered turbine and micro solar array.

FIG. 2 is a pictorial diagram and layout of an exemplar infrared blind spot sensor with a renewable energy power module that consist of a micro wind-powered turbine and micro solar array.

FIGS. 3 is a pictorial diagram and layout of an exemplar blind spot first person view (FPV) camera with a renewable energy power module that consist of a micro wind-powered turbine and micro solar array;

FIG. 4 is a pictorial diagram and layout of an exemplar renewable energy power module that consist of a micro wind-powered turbine and micro solar array;

FIG. 5 is the circuit diagram of an exemplar infrared, ultrasonic and FPV camera blind spot sensor with a renewable energy power module that consist of a micro wind-powered turbine and micro solar array;

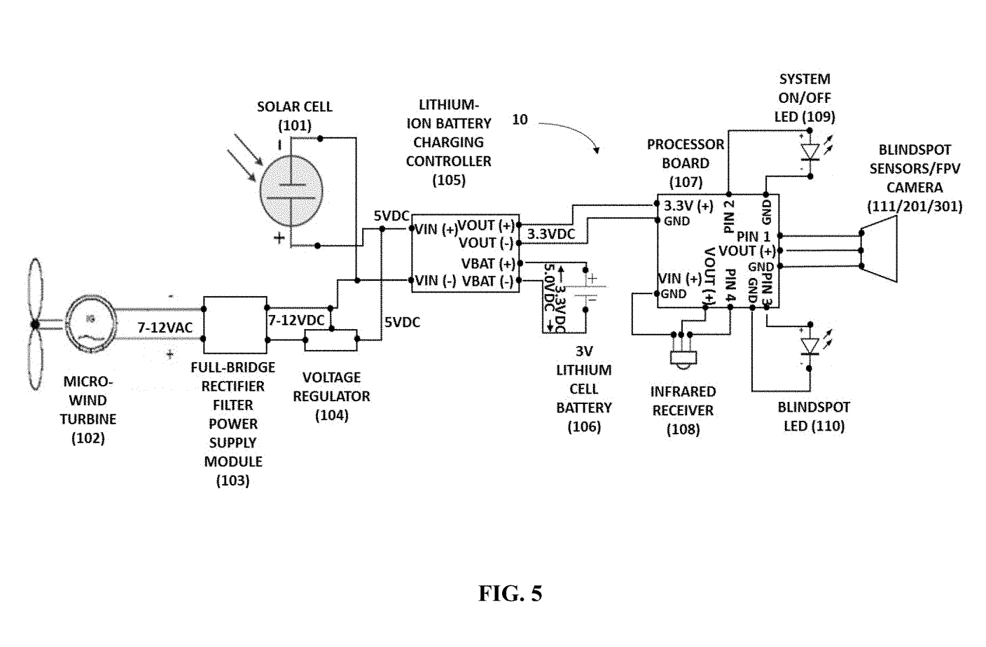

FIG. 6 is the circuit diagram of an exemplar renewable energy power module that consist of a micro wind-powered turbine and micro solar array;

FIG. 7 is a picture of the blind spot sensor side-view mirror support and sensor housing showing the micro-solar cell mounts that create the 3D solar array and adjustable sensor face for optimal sensor transmission or camera view; The housing is IP64 rated, which means that it is fully protected from dust (6) and can also withstand protection from sprays and splashing of water in all directions for up to for up to 5 mins (4).

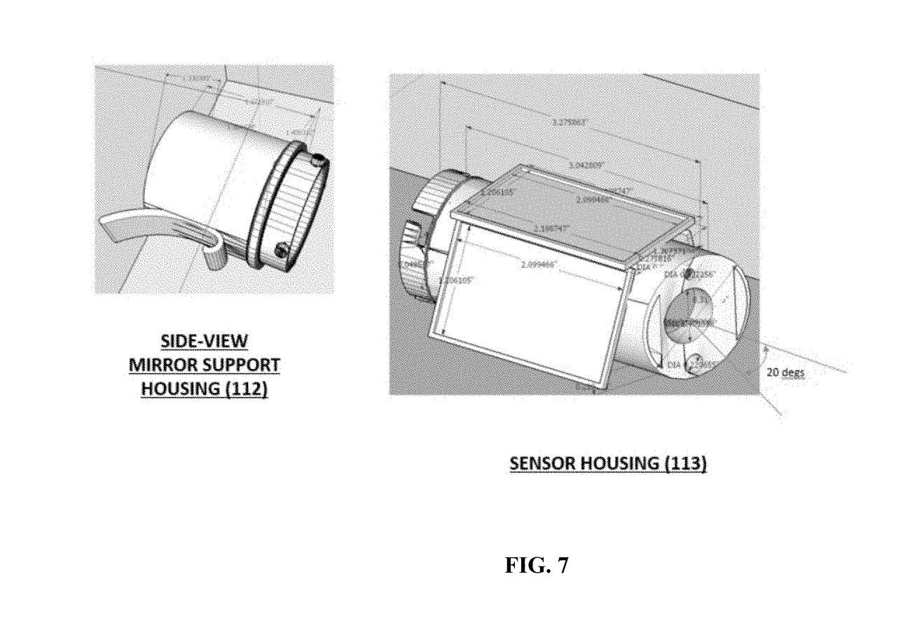

FIG. 8 is a horizontal or top-view layout of vehicle showing the line-of-site from the side-view mirror mounted sensor to the vehicles blind spot;

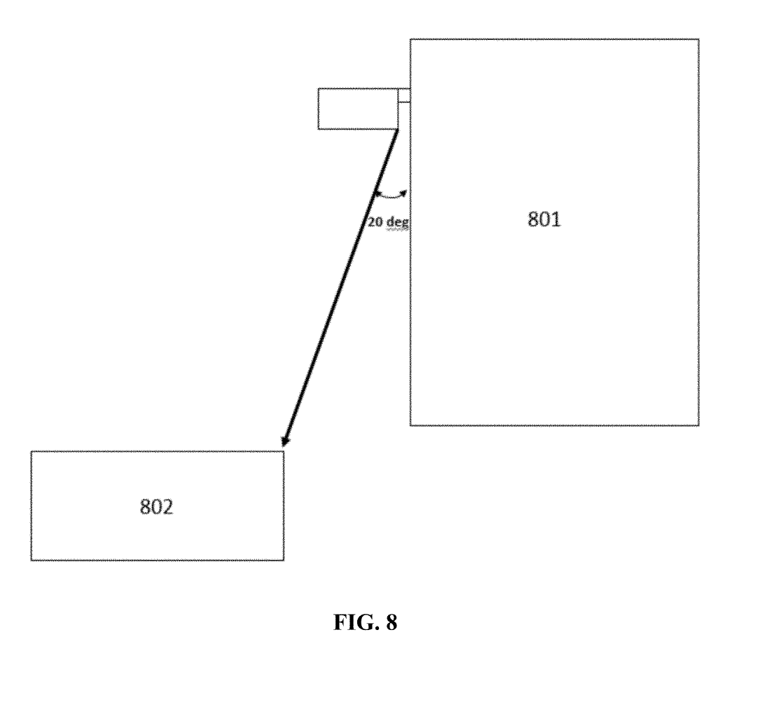

FIG. 9 is a vertical or profile view layout of vehicle showing the line-of-site from the side-view mirror mounted sensor to the vehicles blind spot;

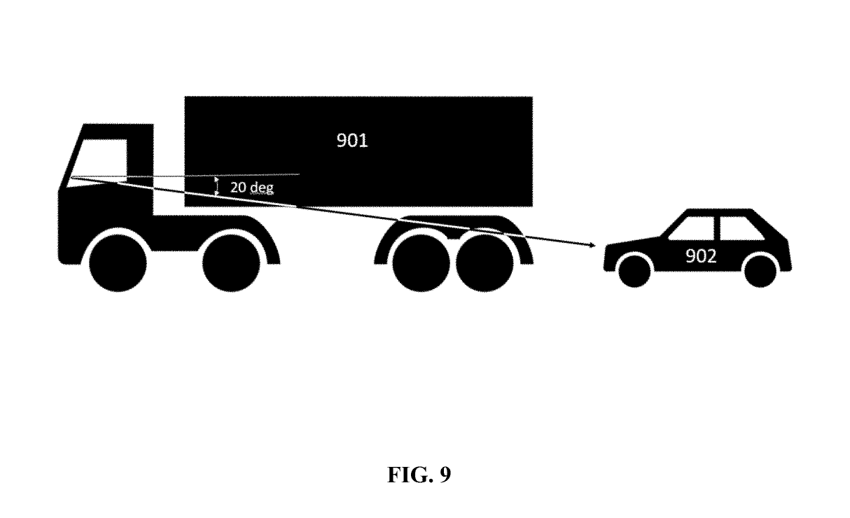

### DESCRIPTION OF THE PREFERRED EMBODIMENT

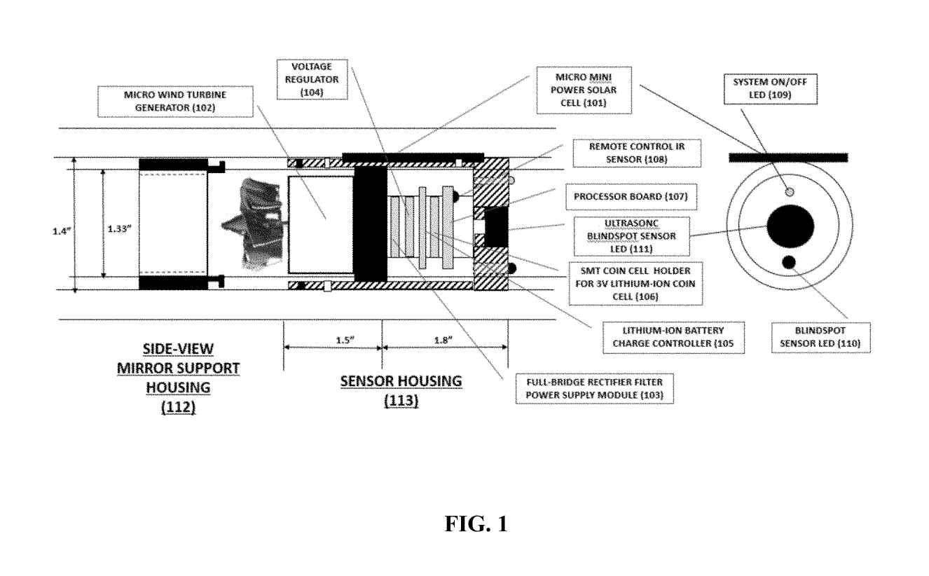

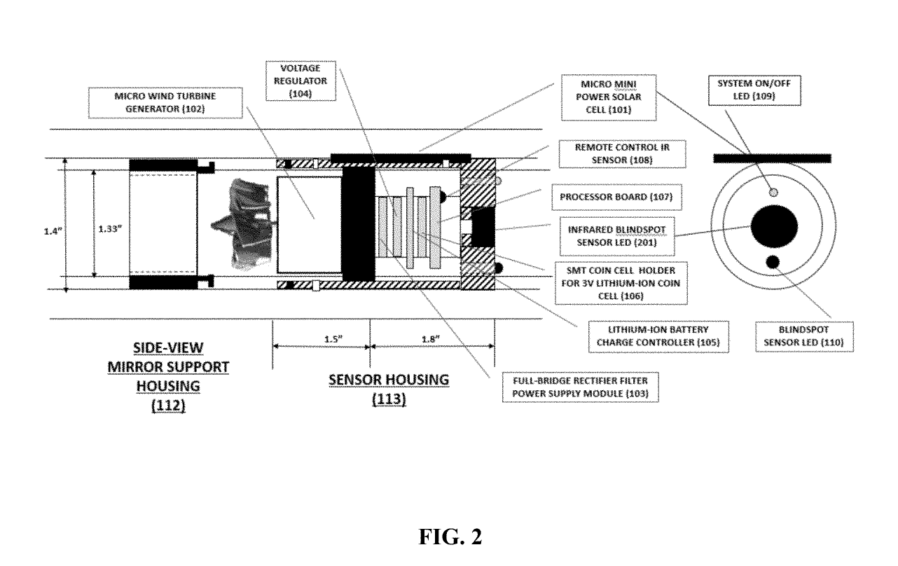

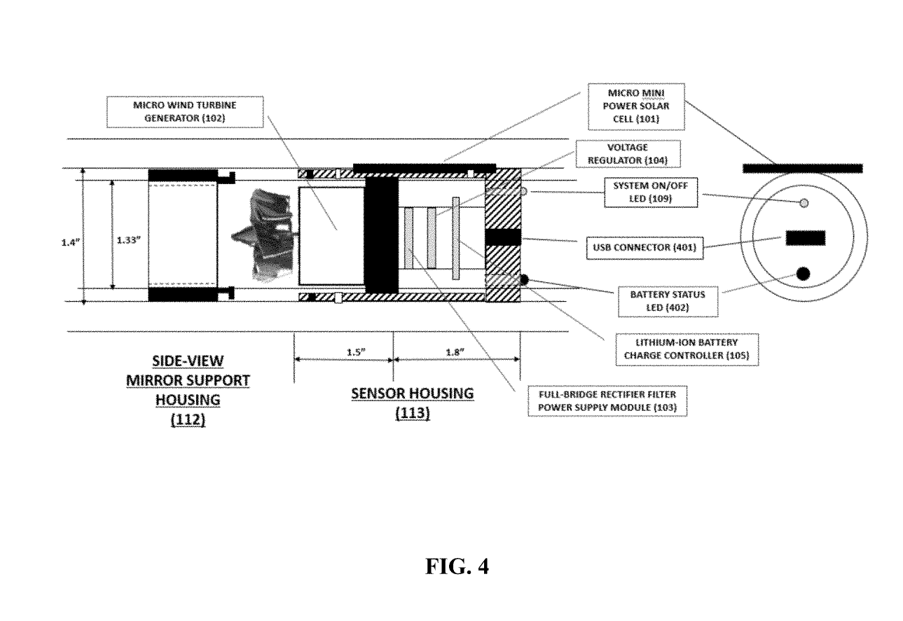

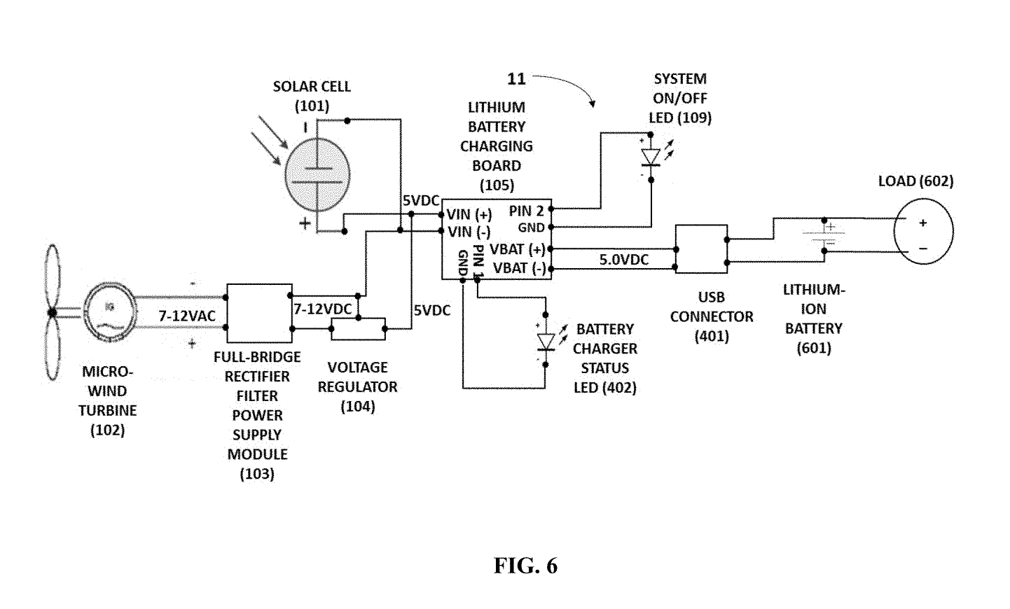

With reference now to the drawings, and in particular to FIGS. 1 through 4 thereof, a new sonic blind spot monitoring system with a renewable energy power module embodying the principles and concepts of the present invention and generally designated by the reference numeral 10 and 11 will be described in FIG. 4 and FIG. 6, respectively.

As best illustrated in FIGS. 1 through 4, the sonic blind spot monitoring system 10 generally comprises a vehicle 801 901. A blind spot sensor 111 201 301 is coupled to the vehicle 801 901 for emitting a sonar wave, infrared beam, or camera focal point into an area adjacent to the vehicle 802 902 corresponding to a blind spot for a driver of the vehicle 801 901.

After market blind spot sensors are available, but many require the installer to connect the system to the vehicle's electrical system in order to power the sensor. A self-contained battery-operated blind spot sensor that would require minimal to zero maintenance requirements can easily be mounted to the side-view mirror. Blind spot sensors can operate on 3V power, however, research has shown that energy required to maintain the battery-operated sensor would be extensive since the blind spot sensor would quickly the drain the battery's voltage during the frequent sensor transmission/receiving and on/off operations. A lithium battery-operated blind spot sensor 111 201 301 with a renewable energy power module with integrated charging circuitry 10, shown in FIG. 4, to recharge the battery 106 and directly power the blind spot sensor 111 201 301 when the battery 106 is fully charged is demonstrated. In addition, in FIG. 6, a renewable energy power module with integrated charging circuitry 11 to recharge a rechargeable battery 601 is demonstrated.

Referring to FIG. 1, the present invention includes all of the components of the renewable energy power module for ultrasonic blind spot sensors. The parts consist of a sensor side-view mirror mount housing 112 and a sensor and circuitry housing 113. The sensor layout consists of a 3D micro-solar cell array 101 and micro-wind turbine 102 as the renewable energy sources. The 3D micro-solar cell array 101 produces 5 voltage direct-current (vdc). The micro-wind turbine 102 produces 5-15 voltage alternating-current (vac) and therefore must be rectified to direct-current voltage (vdc) via a full-bridge rectifier with filter power module 103. The micro-wind turbine direct-current voltage is connected to a 5-volt direct current voltage regulator 104. The turbine 102 and solar cell 101 5 volt direct-current voltages are connected to the lithium-ion battery charge controller 105 that will charge the lithium-ion battery 106 that provides backup power to the processor board 107. The charge controller 105 can also directly power the processor board 107 bypassing the lithium-ion battery 106. The ultrasonic blind spot sensor 111 is connected to the processor board 107 that controls the blind spot ultrasonic sensor LED 110 that notifies the vehicle owner when a vehicle is in its blind spot. The on/off LED 109 notifies the vehicle owner when the system has been turned on or off via the remote control infrared receiver (IR) 108 or via the processor board's auto on-off programming.

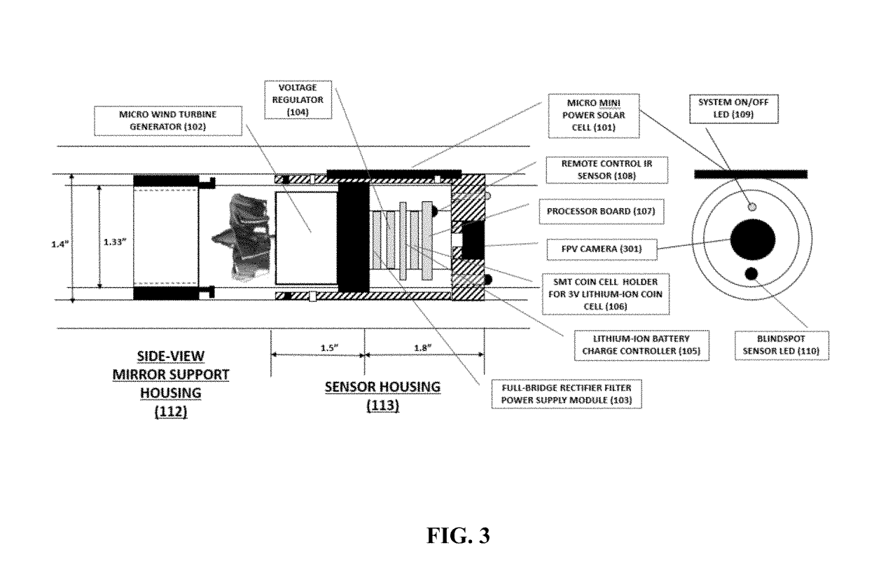

FIG. 3 and FIG. 4 provide same arrangement as describes in FIG. 1, however, The infrared (IR) blind spot sensor 201 and first person view (FPV) camera 301 are connected to the processor board 107 that controls the blind spot sensor LED 110 that notifies the vehicle owner when a vehicle is in its blind spot.

Referring the FIG. 4, the sensor mount housing 112 can be configured to attach to a manual and motorized driven vehicle's body parts along with a sensor and circuitry housing 113 thus a renewable energy power module for low voltage battery charging is invented. The module layout consists of a 3D micro-solar cell array 101 and micro-wind turbine 102 as the renewable energy power sources. The micro-wind turbine 102 produces 5-15 voltage alternating-current (vac) and therefore must be rectified to direct-current voltage (vdc) via a full-bridge rectifier with filter power module 103. In the present embodiment, the micro-wind turbine direct-current voltage is connected to a 5-volt direct current voltage regulator 104. The turbine and solar cell are connected to the lithium battery charging controller 108 that will charge low voltage battery-powered devices' 602 lithium-ion or other type of batteries 601 via a USB connection 401. The solar/wind charge controller 105 powers the charge status LED 402 that notifies the vehicle owner of the status of the battery charge. The solar/wind charge controller 108 powers the on/off LED 107 which notifies the vehicle owner that the power module has been turned on.

In the current embodiment, a micro-wind turbine 102 and 3D micro-solar array 101 that are cable of generating the 5V needed to charge a coin cell 3.3V lithium-ion battery 106 makes up the renewable energy power module. These renewable energy components can easily fit into small housing 112 113 that contains the blind spot ultrasonic sensor and circuitry 10. On sunny days and at minimum speeds, the renewable energy sources can generate enough energy to actually power the blind spot sensors 109 201 301, bypassing the rechargeable battery 106. Even when the vehicle is parked, if it is parked in a sunny area, the charging circuitry will allow the 3D solar array 101 to charge the battery 106 601 and automatically turn off when the charge level is reached.

A sensor housing 112 113 is coupled to the vehicle's 801 901 side-view mirror and contains the display device, a light emitting diode (LED) 110. The sensor housing 112 113 is positioned on the vehicle's 801 901 whereby the display device 110 is visible to the driver of the vehicle 801 901. The display device 110 is operationally coupled to the blind spot sensor 111 201 301 for displaying a visual signal when the blind spot sensor 111 201 301 detects the object in the blind spot. In addition, the first person view (FPV) cameras wireless transmit the blind spot video data to a dash-mounted FPV receiver and video monitor with split screens to see images from the left and right side-view mirror.

A microprocessor 107 is operationally coupled between the blind spot sensor 111 201 301, the charge circuit board 105 and rechargeable battery 106 for activating the display device's LED 110 only upon receiving the reflection of the sonar wave, infrared beam, or camera signal. The on/off LED 109 notifies the vehicle owner when the system has been turned on and of via the remote control infrared receiver (IR) 108. The IR 108 is operationally coupled to the microprocessor 107 and energizes the blind spot sensor circuitry 10 when the “on” button on a remote control is pushed and de-energizes the blind spot sensor circuit 10 when an “off” button on the remote is pressed as described in FIG. 4.

A micro-wind turbine 102 and 3D micro-solar cell array 101 that are capable of generating the 5V needed to charge a coin cell 3.3V lithium-ion battery 601 make up the renewable energy power module. These renewable energy components can easily fit into small housing 112 113 that contains the power module circuitry 11 as shown in FIG. 6.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A blind spot sensor renewable energy power module that contains a 3.3V coin cell lithium-ion rechargeable battery that is capable of powering the blind spot sensor and/or camera.

2. A blind spot sensor renewable energy power module according to claim 1 that contains a micro-wind turbine capable of charging the lithium-ion battery that powers the blind spot sensor and/or camera.

3. A blind spot sensor renewable energy power module according to claim 1 that contains a micro-wind turbine capable of directly powering the blind spot sensor and/or camera.

4. A blind spot sensor renewable energy power module according to claim 1 that contains a micro-solar cell capable of charging the lithium-ion battery that can directly power the blind spot sensor and/or camera.

5. A blind spot sensor renewable energy power module according to claim 1 that contains a micro-solar cell capable of directly powering the blind spot sensor and/or camera.

6. A blind spot sensor renewable energy power module according to claim 1 that contains a three-dimensional (3D) micro-solar cell array that increase the total surface area of the solar array and can produce two to five times as much power as a single flat panel. The 3D array can produce power whenever the sun is near the horizon, i.e. in the morning, evening, winter, or at latitudes far away from the equator. With conventional, flat cells, it's hard to capture low-angle light.

7. A blind spot sensor renewable energy power module according to claim 1 that contains a micro-solar cell that continues to charge the lithium-ion battery even when the vehicle is parked, as long as it's parked in a sunny area.

8. A blind spot sensor renewable energy power module according to claim 1 that contains has key-chain remote control that turns the power module on and off.

9. A blind spot sensor renewable energy power module according to claim 1 that will auto power off and on to save the battery charge if no movement is detected over a certain period of time, e.g., a traffic jam, or the owner forgets to turn off the sensor after parking the vehicle.

10. A blind spot sensor housing with an adjustable face that can direct the sensor beam or camera focus to the blind spot of different types of vehicles; cars, buses, dump trucks, semi-trailers, etc.

11. A blind spot sensor housing according to claim 10 that contains a side-view mirror mount that can be attached the side-view mirror permanently using screws and bolts or semi-permanent using double-side tape.

12. A blind spot sensor housing with according to claim 10 that is easily de-attached from side-view mirror mount and securely stored in the vehicles to prevent theft.

13. A blind spot sensor renewable energy power module that can be decoupled from the blind sensor and/or camera and the module can used to recharge batteries of devices on other vehicle types, bicycles, motorcycles, etc . . . , that generate enough wind and solar energy to create power via the micro-turbine and solar arrays and charge smartphones, LED lights, etc.
